(19) United States
(12) Patent Application Publication
(10) Pub. No.: US 2021/0163058 A1
(43) Pub. Date: Jun. 3, 2021

(54) STEERING SHAFT FOR A VEHICLE AND METHOD FOR PRODUCING SAID STEERING SHAFT

(71) Applicants: thyssenkrupp Presta AG, Eschen (LI); thyssenkrupp AG, Essen (DE)

(72) Inventors: Simon ENDERLIN, Gams (CH); Adam IGRAS, Wil (CH)

(73) Assignees: thyssenkrupp Presta AG, Eschen (LI); thyssenkrupp AG, Essen (DE)

(21) Appl. No.: 17/265,854

(22) PCT Filed: Aug. 20, 2019
(86) PCT No.: PCT/EP2019/072286

§ 371 Date: Feb. 4, 2021

(30) Foreign Application Priority Data
Aug. 21, 2018 (DE) 10 2018 120 314.4

(51) Int. Cl. B62D 1/19; B62D 1/185

(52) U.S. Cl. CPC B62D 1/192; B21H 7/182; B62D 1/185

(57) ABSTRACT

The invention relates to a steering shaft (1) for a vehicle, and to a method for producing a steering shaft of this type. The steering shaft (1) comprises a tubular shaft body (10) which extends along the longitudinal axis (L) and has a first shaft end (11) and a second shaft end (12), a bending section (13) being arranged between the first shaft end (11) and the second shaft end (12), the bending section (13) having a plurality of grooves (21, 22, 23, 24) which run in the circumferential direction of the shaft body (10) for the formation of a groove structure, characterized in that the groove structure is of non-uniform configuration in the direction of the longitudinal axis (L).

The invention relates to a steering shaft for a vehicle in accordance with the preamble of patent claim 1, and to a method for producing a steering shaft for a vehicle in accordance with the preamble of patent claim 10.

Steering shafts are used in vehicles, in particular motor vehicles, in order to transmit a torque between the steering wheel and the steering gear. Steering shafts can be connected at their ends to the steering wheel and to the steering gear. In the case of a vehicle crash, that is to say a collision of the vehicle, undesired further penetration of the steering shaft into the passenger compartment of the vehicle can occur if the steering gear is displaced by way of the crash or the collision. This can lead to injury of the driver of the vehicle.

The prior art has disclosed steering shafts with a corrugated section (corrugated tubes), the steering shaft being deformed, in particular compressed or bent, in the corrugated region in the case of a vehicle crash. The penetration of the steering shaft into the passenger compartment can be avoided or at least reduced by way of compressing or bending.

EP 0 661 117 A1 has disclosed a method for producing a corrugated tube or a metal bellows for steering systems for motor vehicles, in the case of which method a multiplicity of identical annular concavities are configured on the outer circumference of a cylindrical metal tube in order to form a homogeneous structure, in order to obtain an intermediate product. In a second step, a cylindrical core iron is introduced into the intermediate product, and the intermediate product is compressed in the axial direction, the annular concavities being deformed radially to the outside.

DE 10 2009 024 847 A1 discloses an apparatus for producing helical corrugated tubes for adapting the pitch of the corrugation of the corrugated tube.

U.S. Pat. No. 5,503,431 A has disclosed a steering system for motor vehicles with an intermediate shaft which has a cylindrical bellows made from metal which contracts or bends in the case of a collision of the vehicle, in order to absorb the displacement of the steering gear on account of the impact.

The steering shafts which are known from the prior art and methods for producing them have the disadvantage that they are complex to manufacture and the bending characteristic curves of the steering shafts are subject to high fluctuations.

Proceeding from said prior art, it is the object of the present invention to provide a steering shaft with an improved bending behavior, in particular a bending characteristic curve which can be set as precisely as possible. Moreover, a method for producing a steering shaft of this type is to be provided, which is as simple as possible, in particular.

Said object is achieved by way of a steering shaft as claimed in claim 1 and a method as claimed in claim 10. Advantageous developments result from the respective subclaims.

In order to achieve the object, a steering shaft for a vehicle is proposed, comprising a tubular shaft body which extends along a longitudinal axis and has a first shaft end and a second shaft end, a bending section being arranged between the first shaft end and the second shaft end, the bending section having a plurality of grooves which run in the circumferential direction of the shaft body for the formation of a groove structure, characterized in that the groove structure is of non-uniform configuration in the direction of the longitudinal axis.

Thanks to the non-uniform groove structure in the direction of the longitudinal axis, a steering shaft with an improved bending behavior, in particular with a bending characteristic curve which can be set as precisely as possible, can be provided.

The groove structure is formed by way of the plurality of grooves, which run in the circumferential direction, the group structure being of non-uniform configuration. The non-uniform groove structure can be characterized by way of a heterogeneous arrangement and/or heterogeneous configuration of the individual grooves with respect to one another.

The non-uniform groove structure can preferably be characterized in that the grooves are asymmetrical in relation to an arbitrary plane within the bending section, the arbitrary plane being oriented orthogonally with respect to the longitudinal axis. The arbitrary plane is a plane orthogonally with respect to the longitudinal axis in an arbitrary position or arbitrary location of the bending section. In other words, a plane which is oriented orthogonally with respect to the longitudinal axis and with respect to which the grooves are symmetrical does not exist within the bending section.

The groove structure is of non-uniform configuration before the occurrence of a crash, that is to say during normal operation when a crash has not yet occurred. Therefore, the groove structure is non-uniform before the plastic deformation of the bending section in the case of a crash. Therefore, at least two grooves and/or at least two sections between the grooves can have different properties with respect to pressing together (compressing) and/or with respect to bending.

According to the invention, a groove can be understood to mean a depression, in particular a corrugation, which is configured so as to extend over at least a part of the circumference of the corrugated body or the steering shaft (circumferential groove or annular groove). In particular, the groove lies in a plane and perpendicularly with respect to the longitudinal axis of the steering shaft, said groove preferably not having a pitch in the longitudinal direction.

In one advantageous development, the geometry of a first groove can differ from the geometry of a second groove. Therefore, the first groove is of different configuration than the second groove, with the result that a non-uniform groove structure is produced.

The geometry of the grooves with regard to the shape and/or the depth and/or the width of the groove is preferably different. The geometry of a groove is defined, in particular, by way of the shape (cross-sectional shape or depression shape), depth, width and radial extent (internal diameter or external diameter of a groove region). Grooves can fundamentally be configured in various shapes, for example in a channel-shaped manner with a rounded, circular segment-shaped, rectangular, trapezoidal or triangular depression shape.

Therefore, it can be provided that the grooves have a deviating cross section in a longitudinal section along the longitudinal axis, in order to form a non-uniform groove structure in this way.

As an alternative or in addition, the spacing between a first groove and a second groove and the spacing between the second groove and a third groove can differ from one another.

According to the invention, the spacing between two grooves can be the axial spacing between the center lines of the respective groove, which center lines run, in particular, along the greatest depth of the respective groove. The depth of a groove can be understood to mean the maximum radial extent of the groove, in particular starting from a circumferential face of the shaft body or the steering shaft. The width of a groove can be understood to mean the maximum axial extent of the groove (axial groove region), in particular the width of the depression in a circumferential face of the shaft body or the steering shaft. The bending section comprises a plurality of grooves, in particular between two and ten grooves.

The shaft body is produced from a tube which is preferably circular-cylindrical, preferably made from a metallic material such as steel or aluminum, or from a fiber composite material, and configured, in particular, as a hollow body. The coupling to a steering wheel and a steering gear of a vehicle can be provided in an indirect or direct manner, in particular via further intermediate shafts, preferably via shaft end sections of the shaft body, which shaft end sections can be connected by way of joints.

The invention includes, inter alia, embodiments which are such that they have grooves with geometries (shapes, depths or widths) which are different than one another or grooves which are spaced apart from one another to a different extent, and also embodiments which combine various geometries and various spacings with one another.

It can be provided in one advantageous development that the grooves are strengthened locally in each case to a different extent, for example by way of a corresponding forming operation and/or by way of local laser strengthening. A first groove and a second groove can have a different hardness and/or strength and/or rigidity.

A steering shaft according to the invention is configured, in particular, to be deformed, in particular to be bent, in the case of a vehicle crash, in the case of which, in particular, a steering gear is displaced in the direction of the steering wheel, in order to prevent a penetration of the steering shaft—more explicitly, a further penetration of the steering shaft than provided during normal operation—into the passenger region/passenger cell. It is one concept of the invention that the mechanical bending behavior (bending deformation) of the steering wheel can be set as precisely as possible, that is to say in a manner which is adapted to the desired behavior in the case of a vehicle crash, by way of a suitable design of a bending section of the steering shaft by way of a multiplicity of grooves in order to provide an non-uniform groove structure. In particular, the profile of the section modulus can be specified structurally in the longitudinal direction, that is to say in the direction of the longitudinal axis of the steering shaft. In particular, by way of the suitable shaping of grooves in a bending section in order to form a non-uniform groove structure, a steering shaft can be constructed in such a way that a desired bending characteristic curve of the steering shaft is set. The bending characteristic curve can be understood to mean the (plastic) deformation or displacement on account of bending in a manner which is dependent on the forces which act on the steering shaft. Apart from by way of the selection of the material and the diameter of the steering shaft, the bending behavior can be influenced structurally according to the invention by way of suitable positioning of the bending section and/or the grooves in the longitudinal direction and by way of the selection of the number of grooves, their geometry and their spacings from one another. In particular, the bending region is designed such that the steering shaft according to the invention begins to deform (bend), on account of the non-uniform group structure, in the case of lower loads in the region of a first groove than in the region of a second groove. A steering shaft according to the invention has the advantage that the bending behavior can be set precisely. Moreover, the steering shaft can be produced simply.

In one development of the invention, the depth of the grooves, the width of the grooves and/or the spacing of two grooves increase/increases or decrease/decreases, preferably continuously, from a side of the bending section, which side faces the first shaft end, toward a side of the bending section, which side faces the second shaft end. In particular, the geometry of the grooves and spacings between (axially adjacent) grooves changes in a stepped manner (uniformly) from one side of the bending section to the other, with the result that an non-uniform groove structure is configured in the direction of the longitudinal axis.

Grooves are preferably of deeper and/or wider configuration on a side which faces the steering gear than on that side of the bending section which faces the steering wheel. The spacings between the grooves preferably decrease from a side which faces the steering gear toward that side of the bending section which faces the steering wheel. In this way, setting of the bending behavior of the steering shaft which is as precise as possible can be achieved, in particular a continuous profile of the section modulus and/or the (plastic) bending in the longitudinal direction, in order to achieve a desired deformation of the steering shaft in the case of a vehicle crash.

In one advantageous development of the invention, the wall thickness of the shaft body in a groove region of a first groove and in a groove region of a second groove differ from one another in order to form an non-uniform groove structure in the direction of the longitudinal axis. In particular, each groove extends over an associated (axial) groove region which is in each case one (axial) part region of the bending section of the shaft body and therefore forms the groove structure in sections. The wall thickness can be understood to be half the difference between the external diameter and the internal diameter of the shaft body in the respective groove region, in particular on the center line of the respective groove. In particular, the wall thickness between adjacent grooves increases or decreases in a stepped manner (uniformly) from one side of the bending section to the other side of the bending section. The wall thickness is preferably smaller on a side which faces the steering gear than on a side of the bending section, which side faces the steering wheel. A variation of the wall thickness can be achieved simply, in particular, by way of the degree of reshaping of a tube which serves as a shaft body during the production of the steering shaft. The groove region of an individual groove can have different wall thicknesses; the wall thickness is preferably smallest at the deepest point of the groove. The deepest point of the groove is that point, at which the groove has the smallest external diameter. The wall thickness of the groove preferably means the smallest wall thickness of the corresponding groove.

The wall thickness of each groove in the bending section is preferably smaller than the wall thickness of the shaft body outside the bending section.

In one advantageous development of the invention, at least one groove, preferably all the grooves, is/are configured so as to be recessed inward in an outer circumferential face of the shaft body, in particular so as to be curved into an interior cavity of the shaft body. In particular, the external diameters of the grooves are smaller than the external diameter of the steering shaft, the internal diameters of the groove preferably being smaller than the internal diameter of the steering shaft. The external and internal diameter of the steering shaft can be determined outside the bending section, in particular in a shaft side section. The grooves are formed, in particular, on the outer circumferential face of the shaft body by way of (local) forming into the wall of the shaft body (being pushed or pressed in). As a result, the external diameter of the steering shaft does not increase during the production process in comparison with a tube before the forming operation.

In one advantageous development, the tubular shaft body has an enveloping circle diameter and a wall thickness outside the bending section, an enveloping circle diameter of the bending section being smaller than or equal to the sum of the enveloping circle diameter of the tubular shaft body and twice the wall thickness of the tubular shaft body. The sum is therefore the enveloping circle diameter of the tubular shaft body outside the bending section plus two times (twice) the wall thickness of the tubular shaft body outside the bending section. The enveloping circle diameter of the tubular shaft body preferably corresponds to the external diameter of the tubular shaft body.

The enveloping circle diameter of the bending section is particularly preferably smaller than or equal to the enveloping circle diameter of the tubular shaft body. As a result, the non-uniform groove structure according to the invention can be realized in a compact installation space, it being possible for the advantages of the structural adaptation of the bending behavior in the case of a crash to be realized in a small space. The wall thickness of the tubular shaft body can be understood to mean half the difference between the external diameter and the internal diameter of the shaft body outside the bending section.

In one advantageous development of the invention, the bending section has at least three, preferably at least four, grooves which are in each case of different depth and/or are at a different spacing from one another in each case. More than four grooves can also be provided, in particular up to ten grooves. Three or four grooves which are configured according to the invention firstly make an improved, in particular sufficiently continuous, bending behavior possible, and are secondly simple and inexpensive to produce. It is already possible, however, to provide a corresponding bending behavior with only two grooves for the formation of a non-uniform groove structure.

In one advantageous development of the invention, the depth of a groove is between 0.1 and 3 times, preferably between 0.2 and 2 times, further preferably between 0.3 and 1.5 times, further preferably between 0.4 and 1 time, a wall thickness of the shaft body outside the bending section. The wall thickness can be understood to be half the difference between the shaft external diameter and the shaft internal diameter. Depths of this type of the grooves result in a sufficient change in the section modulus against bending in comparison with a shaft body without a bending section for influencing the bending behavior of the steering shaft in a suitable manner.

Moreover, the object is achieved, in particular, by way of a method for producing a steering shaft for a vehicle, in particular a steering shaft according to the invention, comprising the following steps:
a) providing of a tube which extends along a longitudinal axis;
b) forming of the tube in order to configure a tubular shaft body of a steering shaft with a bending section which is arranged between a first and a second shaft end of the shaft body, at least two grooves which run in the circumferential direction of the shaft body being formed in the circumferential face of the tube by way of at least one roller, the rolling axis of which runs at least substantially parallel to the longitudinal axis, in such a way that
   the geometries of a first and a second groove differ from one another, in particular with regard to the shape, the depth and/or the width of the groove,
   and/or
   the spacing between a first and a second groove and the spacing between the second and a third groove differ from one another.

Moreover, the object is achieved, in particular, by way of a method for producing a steering shaft for a vehicle, comprising the following steps:
providing of a tube which extends along a longitudinal axis with an enveloping circle diameter and a wall thickness;
forming of the tube in order to configure a tubular shaft body of a steering shaft with a bending section which is arranged between a first shaft end and a second shaft end of the shaft body, at least one groove which runs in the circumferential direction of the shaft body being formed into a circumferential face of the tube by way of rolling of at least one roller,
characterized in that
the enveloping circle diameter of the bending section is smaller than or equal to the sum of the enveloping circle diameter of the tube and twice the wall thickness.

Therefore, before the forming, the tube has an enveloping circle diameter and a wall thickness, said enveloping circle diameter and the wall thickness which corresponds to that outside the bending section of the tube after the forming operation, the enveloping circle diameter of the bending section being smaller than or equal to the sum of the enveloping circle diameter of the tube and twice the wall thickness of the tube. The sum is therefore the enveloping circle diameter of the tube either before the forming operation or outside the bending section plus twice the wall thickness of the tube before the forming operation or outside the bending section.

The enveloping circle diameter of the bending section is particularly preferably smaller than or equal to the enveloping circle diameter of the tube. As a result, the non-uniform groove structure according to the invention can be realized in a compact installation space, it being possible for the advantages of the structural adaptation of the bending behavior in the case of a crash to be realized in a small space.

The forming of the at least one groove by way of the rolling of a roller on the circumferential face of the tube preferably takes place in such a way that the tube is plastically deformed partially, that is to say locally. After the forming operation, that is to say when all the grooves for the formation of the bending section have been made, regions which are not deformed exist in the bending section and/or outside the bending section.

The bending section is configured, in particular, by way of cold forming of the tube, it being possible for forming of a groove to be understood to mean, in particular, the pushing or pressing of a roller into the tube, in particular into its wall material. During forming, in particular, the roller exerts a forming force (pressing force) on the circumferential face of the tube, in order to plastically deform the wall material locally for the configuration of a groove. In particular, the tube and the at least one roller roll against one another, the tube and the roller preferably rotating in opposite directions. The tube or the roller can also be at a standstill, however, while only the roller or the tube rotates.

The bending section preferably has a plurality of grooves, which run in the circumferential direction of the shaft body for the formation of a groove structure, the groove structure being of non-uniform configuration in the direction of the longitudinal axis.

The method according to the invention can implement some or all of the process features which have been described in conjunction with the steering shaft according to the invention, and has similar advantages. In particular, a bending section can be configured in a simple way by way of the method, in such a way, preferably also in such a way, that a desired bending behavior of the steering shaft is set.

In one advantageous development of the invention, the grooves are formed by way of a roller, at least one first groove being formed in a first longitudinal position of the roller, and a second groove being formed in a second longitudinal position of the roller, which second longitudinal position is spaced apart axially from said first longitudinal position, the roller being advanced, in particular, to a different extent onto the circumferential face of the tube in the first and second longitudinal position, and/or the longitudinal positions of the roller being spaced apart from one another to a different extent. In particular, a single roller is provided for forming a plurality of grooves. The roller can be moved, preferably displaced or driven, from the first into the second longitudinal position relative to the tube, or vice versa. The shape of a groove corresponds, in particular, to the surface shape of a rolling face of the roller. A production apparatus which corresponds to the method with one (axially displaceable) roller is of simple construction and control. Grooves at various spacings can be formed in a simple manner. In order to form grooves of various depths, the roller can be displaced in the radial direction of the steering shaft. The roller is preferably moved in a motorized, pneumatic or hydraulic manner for advancing purposes. The roller can be advanced further during the forming operation, it being possible for the forming operation to comprise a plurality of revolutions of the roller.

In one alternative advantageous development of the invention, the grooves are formed by way of at least two rollers which are spaced apart axially from one another, are arranged, in particular, along a common rolling axis, and have a different roller geometry, in particular a different roller diameter, and/or different spacings between a first roller and a second roller and between the second roller and a third roller. The rollers are mounted, in particular, on a common roller axle at predefined spacings from one another. Each groove to be formed is preferably assigned a roller. The rollers can have identical or different rolling face shapes or roller widths.

In one advantageous development of the invention, the length of the tube is substantially identical before and after the forming. “Substantially identical” is understood to mean deviation of ±5% of the original length of the tube. The length of the tube is particularly preferably identical before and after the forming. In particular, the tube can be clamped in axially on both sides during the forming, in order to prevent lengthening or compression of the tube. In this way, a prefabricated tube blank can be installed, even after the forming, with the provided length dimensions as a finished steering shaft into a steering arrangement of a vehicle. Therefore, machining for the adaptation of the length after the forming operation is not required. The steering shaft which is produced in accordance with the method according to the invention is preferably a steering shaft according to the invention in accordance with the teaching according to the invention.

Exemplary embodiments of the invention will be described in greater detail in the following text on the basis of the drawings, in which:

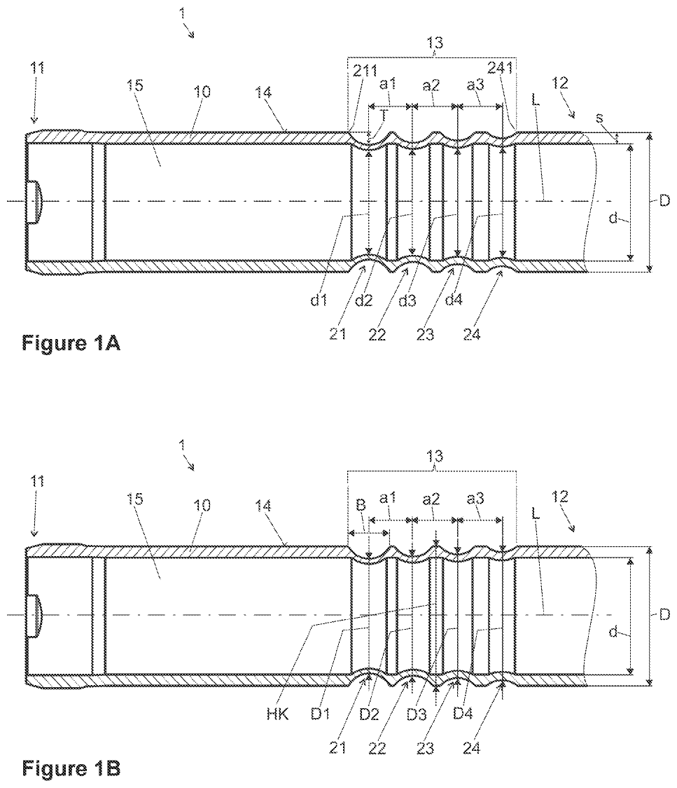

FIG. 1A shows a schematic illustration of a first embodiment of a steering shaft according to the invention with grooves of different geometry for the provision of a non-uniform groove structure, in a half section view,

FIG. 1B shows a schematic illustration of the embodiment according to FIG. 1A with illustrated external diameters of the respective groove regions,

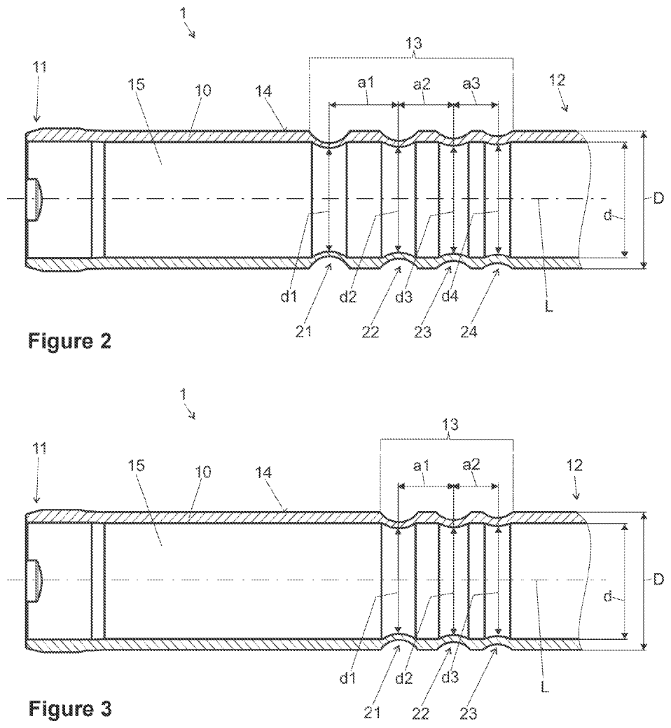

FIG. 2 shows a schematic illustration of a second embodiment of a steering shaft according to the invention with grooves which are spaced apart from one another to a different extent for the provision of a non-uniform groove structure, in a half section view,

FIG. 3 shows a schematic illustration of a third embodiment of a steering shaft according to the invention with three grooves which are spaced apart from one another to a different extent for the provision of an non-uniform groove structure, in a half section view,

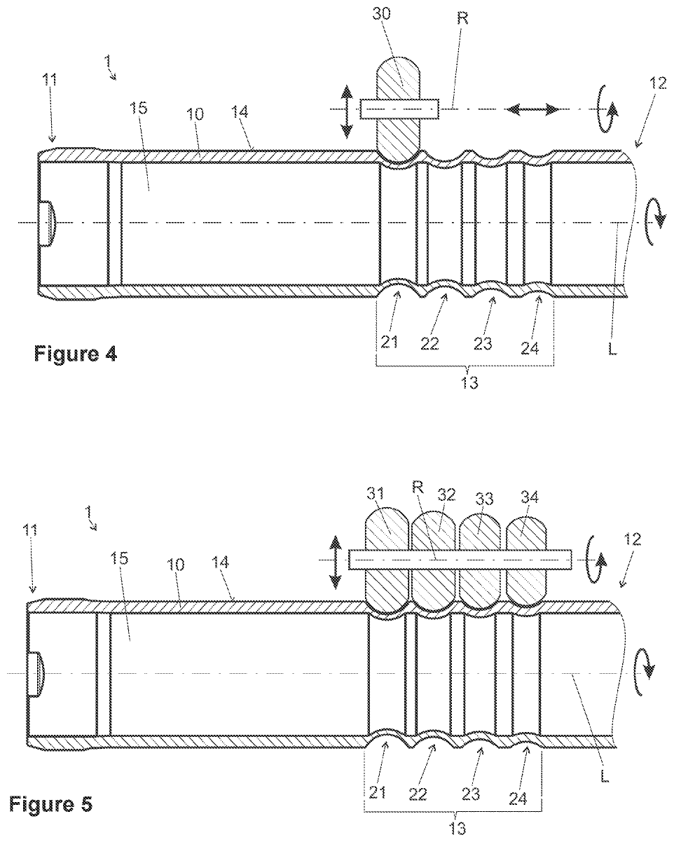

FIG. 4 shows a schematic illustration of a first embodiment of the production method according to the invention for a steering shaft with a roller which can be advanced, in a half section view,

FIG. 5 shows a schematic illustration of a second embodiment of the production method according to the invention for a steering shaft with a plurality of rollers, in a half section view,

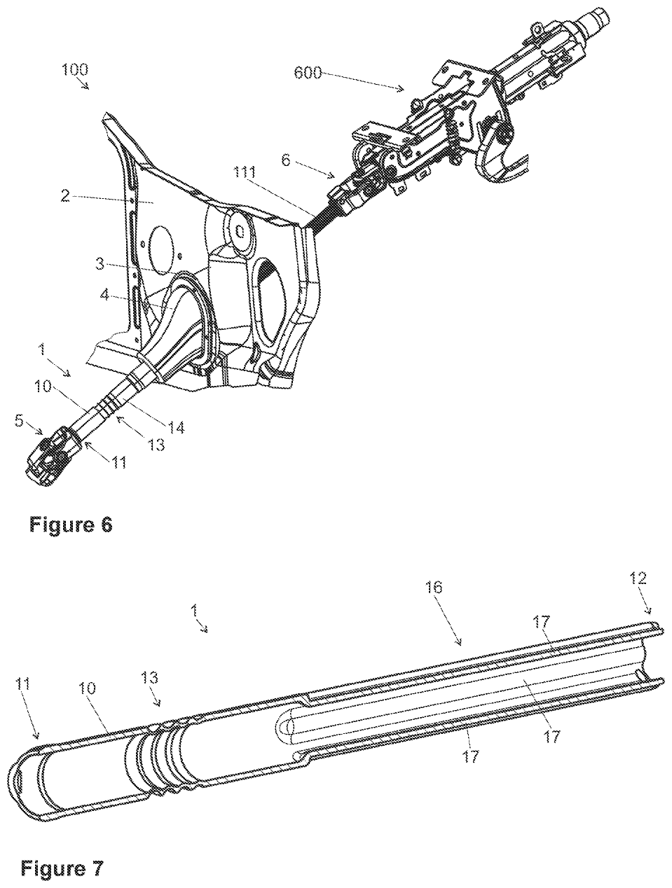

FIG. 6 shows a schematic illustration of a steering arrangement with a steering shaft according to the invention, in a perspective view,

FIG. 7 shows a schematic illustration of a fourth embodiment of a steering shaft according to the invention, in a half section view,

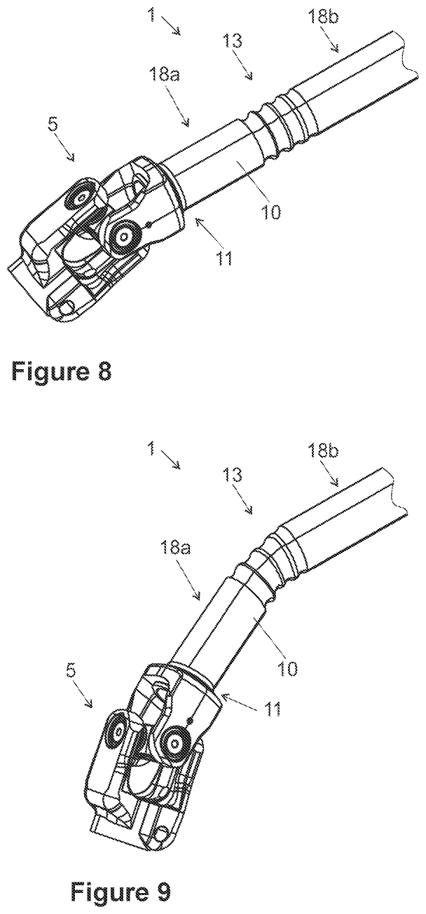

FIG. 8 shows a schematic illustration of a steering shaft according to the invention in the unbent state during normal operation, and

FIG. 9 shows a schematic illustration of the steering shaft according to FIG. 8 in the bent state after a crash.

In the following description of the invention, the same designations are used for identical and identically acting elements.

FIGS. 1A and 1B show one embodiment of a steering shaft 1 according to the invention with a shaft body 10 which has a first shaft end 11 and a second shaft end 12 which are provided for articulated coupling to a steering gear and a steering wheel of a vehicle. The tubular shaft body 10 is configured as a hollow shaft with a longitudinal axis L, an internal diameter d, an external diameter D which can also be called the enveloping circle diameter of the tubular shaft body 10 outside the bending section 13, and an interior cavity 15. The enveloping circle diameter is the diameter of the enveloping circle, by which the cross section of the shaft body 10, which cross section is oriented orthogonally with respect to the longitudinal axis, is circumscribed. Furthermore, the shaft body 10 has a wall thickness s which corresponds to half the difference of the external diameter and the internal diameter. Four grooves 21, 22, 23, 24 are formed into the outer circumferential face 14 of the shaft body 10 at identical spacings a1, a2, a3 from one another in a bending section 13 of the shaft body 10. The bending section 13 comprises four grooves 21, 22, 23, 24 which in each case have a different geometry, with the result that a non-uniform groove structure according to the invention is configured in the direction of the longitudinal axis L. The bending section 13 is delimited by way of the outer edges 211, 241 of the outer grooves 21, 24. The enveloping circle diameter HK of the bending section 13 is that diameter of the enveloping circle which circumscribes the maximum cross section of the bending section 13, which maximum cross section is oriented orthogonally with respect to the longitudinal axis. In other words, the enveloping circle diameter HK of the bending section 13 is the maximum external diameter in the bending section 13. The grooves 21, 22, 23, 24 are configured as annular grooves so as to run around the shaft body 10 in the circumferential direction, and configure depressions of circular segment-shaped cross section with respect to the circumferential face 14. The depth T of the axially adjacent grooves decreases from the first groove 21 on a side which faces the steering gear (on the left in the figures) as far as a side which faces the steering wheel (on the right in the figures) as far as the fourth groove 24. Accordingly, the external diameters D1, D2, D3, D4 which are illustrated in FIG. 1B of the associated grooves 21, 22, 23, 24 increase from left to right (D1<D2<D3<D4). The internal diameters d1, d2, d3, d4 of the associated grooves 21, 22, 23, 24 likewise increase from left to right (d1<d2<d3<d4). The wall thicknesses, for example defined by way of half the difference between the respective external diameter D1, D2, D3, D4 and the internal diameter d1, d2, d3, d4, that is to say, for example, (D1−d1)/2, in the respective groove regions increase from left to right. The diameters are determined in each case along a center line of the groove, that is to say in the center of the axial groove region or at the deepest point of the groove. The shaft body 10 curves inward into the interior cavity 15 in the bending section 13 in the groove regions. The external diameters D1, D2, D3, D4 in the groove regions are smaller than the external diameter D of the shaft body 10, and the internal diameters d1, d2, d3, d4 are smaller is the internal diameter d of the shaft body 10. The tubular shaft body 10 therefore has an enveloping circle diameter D and a wall thickness s outside the bending section 13, the enveloping circle diameter HK of the bending section 13 being smaller than the sum of the enveloping circle diameter D of the tubular shaft body 10 and twice the wall thickness (2s) of the tubular shaft body 10. In the shaft side sections to the side of, that is to say outside, the bending section 13, the shaft body 10 has substantially constant cross section, or a constant external diameter D and internal diameter d. The diameters and wall thicknesses of the shaft body 10 can also vary in the longitudinal direction L outside the region 13, however, for example for the provision of a coupling section for coupling the shaft body 10 to a fork of a universal joint.

FIG. 2 shows a second embodiment of a steering shaft 1 according to the invention which differs from the steering shaft 1 which is shown in FIGS. 1A and 1B in that the spacings a1, a2, a3 between in each case two adjacent grooves 21, 22, 23 and 24 are different, as a result of which an non-uniform groove structure according to the invention is provided in the direction of the longitudinal axis L. The spacings a1, a2, a3 shorten from left to right. The first spacing a1 between the first groove 21 and the second groove 22 is greater than the second spacing a2 between the second groove 22 and the third groove 23, which second spacing a2 is in turn greater than the third spacing a3 between the third groove 23 and the fourth groove 24.

FIG. 3 shows a third embodiment of a steering shaft according to the invention which corresponds to that in FIG. 2, the bending section 13 comprising only three grooves 21, 22, 23 with spacings a1 and a2 which are different than one another for the formation of an non-uniform groove structure.

The steering shafts 1 which are shown in FIGS. 1A to 3 have bending sections 13 with an non-uniform groove structure, which bending sections 13 bring about a defined bending behavior of the steering shaft 1 if, in the installed state, the latter is deformed by way of the forces which act in the case of a vehicle crash. Via the non-uniform groove structure such as the number, the geometry (depth T, width B) of the grooves and/or the spacings of the grooves from one another, the section modulus of the shaft body 10 with respect to deformation can be set locally, as a result of which the bending behavior of the overall steering shaft 1 can be influenced in accordance with a desired shape in the case of a vehicle crash (see FIGS. 8 and 9).

FIGS. 4 and 5 illustrate two alternative embodiments of a production method according to the invention for a steering shaft 1, comprising the following steps:
providing of a tube which extends along a longitudinal axis L with an enveloping circle diameter D and a wall thickness s;
forming of the tube for the configuration of a tubular shaft body 10 of a steering shaft 1 with a bending section 13 which is arranged between a first shaft end 11 and a second shaft end 12 of the shaft body 10,

at least one groove 21, 22, 23, 24 which runs in the circumferential direction of the shaft body 10 being formed into a circumferential face 14 of the tube by way of rolling of at least one roller 30, 31, 32, 33, 34. According to the invention, the enveloping circle diameter HK of the bending section 13 is smaller than or equal to the sum of the enveloping circle diameter D of the tube and twice the wall thickness.

As in the design variants of FIGS. 4 and 5, this can have a bending section 13 with four grooves 21, 22, 23, 24 of different geometry, in particular of different depth T and width B, in order to achieve a defined bending behavior. In the case of the methods which are shown, at least one roller 30 which is mounted such that it can be rotated about a rolling axis R (see FIG. 4) or rollers 31, 32, 33, 34 (see FIG. 5) is/are advanced in the radial direction (see radial double arrow) toward the circumferential face 14 of a tube which forms the shaft body 10, in order to exert a forming force on the tube. In this design variant, the rolling axis R and the longitudinal axis L are oriented substantially parallel to one another. The rollers 30, 31, 32, 33, 34 and the shaft body 10 rotate counter to one another (see arrows for rotational directions), preferably rolling on one another or turning on one another.

In the case of the production method which is illustrated in FIG. 4, a single roller 30 is provided which can be displaced axially in the longitudinal direction L (see axial double arrow), in order to form in each case one of the grooves 21, 22, 23, 24 in the tube at various longitudinal positions. Accordingly, the grooves 21, 22, 23, 24 are formed one after another. The tube might also be displaced or moved relative to the roller 30 (to the left in FIG. 4). Therefore, the bending section 13 has a plurality of grooves 21, 22, 23, 24 which run in the circumferential direction of the shaft body 10 for the formation of a groove structure, the groove structure being of non-uniform configuration in the direction of the longitudinal axis L.

In the case of the production method which is illustrated in FIG. 5, four rollers 31, 32, 33, 34 which are mounted such that they can be rotated about a common rolling axis are provided, all of the grooves 21, 22, 23, 24 being formed at the same time. The spacings of the rollers 31, 32, 33, 34 from one another can be variable, in order to produce different spacings a1, a2, a3 of the grooves 21, 22, 23, 24 from one another. Therefore, the bending section 13 has a plurality of grooves 21, 22, 23, 24 which run in the circumferential direction of the shaft body 10 for the formation of a groove structure, the groove structure being of non-uniform configuration in the direction of the longitudinal axis L.

The methods according to the invention have the advantage that a steering shaft 1 with a bending section 13 can be produced simply and has merely a small installation space requirement.

FIG. 6 shows a steering arrangement 100 which is known per se and comprises a steering shaft 1 according to the invention with a bending section 13, the bending section 13 having a plurality of grooves 21, 22, 23, 24 which run in the circumferential direction of the shaft body 10 for the formation of a groove structure, the groove structure being of non-uniform configuration in the direction of the longitudinal axis L. The steering shaft 1 is coupled to a joint 5 which faces a steering gear and to a joint 6 which faces a steering wheel. The steering wheel 1 protrudes through a bulkhead leadthrough 4 in a bulkhead 2.

The bulkhead leadthrough 4 is sealed by way of a sealing cuff 3 against spray water. The steering shaft is mounted rotatably in a steering column 600 between the joint 6 and the steering wheel (not shown), the steering column being configured as a manually adjustable steering column 600. As an alternative, other types of steering columns can also be used, such as rigid steering columns or electrically adjustable steering columns.

FIG. 7 shows one embodiment of a steering shaft 1 according to the invention with a sliding shaft section 16 which has positively locking elements 17 which are oriented in the longitudinal direction. An inner shaft 111 can be pushed into the sliding shaft section 16, said inner shaft 111 having complementary positively locking elements which can be brought into engagement with the positively locking elements 17 for the transmission of a torque. The inner shaft 111 and the shaft body 10 can be configured such that they can be telescoped with respect to one another.

FIG. 8 shows one embodiment of a steering shaft 1 according to the invention in the non-deformed (unbent) state during normal operation with a non-uniform groove structure before the occurrence of a crash. FIG. 9 shows the steering shaft 1 from FIG. 8 in the deformed (bent) state after the occurrence of a crash. The steering shaft 1 is bent, in particular, in the bending section 13, whereas the shaft side sections 18a and 18b which are arranged on both sides thereof are not bent or are bent merely slightly. As a result of the non-uniform groove structure according to the invention (see FIGS. 1 to 5), the bending section 13 overall is less flexurally stiff than the two shaft side sections 18a, 18b, a defined bending behavior (bending characteristic curve) and/or a resulting bending deformation and/or compression of the steering shaft 1 being specified structurally. The bending behavior can be predetermined by way of the non-uniform groove structure, for example by way of a suitable selection of the geometry and/or the spacings a1, a2, a3 of the grooves 21, 22, 23, 24, in such a way that, in the case of a vehicle crash, the steering shaft 1 does not penetrate into the passenger compartment of the vehicle 1. As a result, the risk of injury for the driver is reduced.

1. A steering shaft (1) for a vehicle, comprising
a tubular shaft body (10) which extends along a longitudinal axis (L) and has a first shaft end (11) and a second shaft end (12), a bending section (13) being arranged between the first shaft end (11) and the second shaft end (12),
the bending section (13) having a plurality of grooves (21, 22, 23, 24) which run in the circumferential direction of the shaft body (10) for the formation of a groove structure, characterized in that the groove structure is of non-uniform configuration in the direction of the longitudinal axis (L).

2. The steering shaft as claimed in claim 1, characterized in that the geometry of a first groove (21) differs from the geometry of a second groove (22).

3. The steering shaft as claimed in either of the preceding claims, characterized in that a first groove (21) is at a first spacing (a1) from a second groove (22), the second groove (22) being at a second spacing (a2) from a third groove (23), the first spacing (a1) differing from the second spacing (a2).

4. The steering shaft as claimed in one of the preceding claims, characterized in that a depth of the grooves (21, 22, 23, 24), a width of the grooves (21, 22, 23, 24) and/or the spacing of two grooves (21, 22, 23, 24) increases or decreases from a side of the bending section (13), which side faces the first shaft end (11), toward a side of the bending section (13), which side faces the second shaft end (12).

5. The steering shaft as claimed in one of the preceding claims, characterized in that the wall thickness of the shaft body (10) in a groove region of a first groove (21) and that in a groove region of a second groove (22) differ from one another.

6. The steering shaft as claimed in one of the preceding claims, characterized in that at least one groove (21, 22, 23, 24) is configured so as to be recessed inward in an outer circumferential face (14) of the shaft body (10).

7. The steering shaft as claimed in one of the preceding claims, characterized in that the bending section (13) has at least three grooves (21, 22, 23, 24) which are in each case of different depth and/or are at a different spacing from one another in each case.

8. The steering shaft as claimed in one of the preceding claims, characterized in that the depth of a groove (21, 22, 23, 24) is between 0.1 and 3 times a wall thickness of the shaft body (10) outside the bending section (13).

9. The steering shaft as claimed in one of the preceding claims, characterized in that the tubular shaft body (10) has an enveloping circle diameter (D) and a wall thickness (s) outside the bending section (13), an enveloping circle diameter (HK) of the bending section (13) being smaller than or equal to the sum of the enveloping circle diameter (D) of the tubular shaft body (10) and twice the wall thickness (s) of the tubular shaft body (10).

10. A method for producing a steering shaft for a vehicle, comprising the following steps:
providing of a tube which extends along a longitudinal axis (L) with an enveloping circle diameter (D) and a wall thickness (s);
forming of the tube in order to configure a tubular shaft body (10) of a steering shaft (1) with a bending section (13) which is arranged between a first shaft end (11) and a second shaft end (12) of the shaft body (10),
at least one groove (21, 22, 23, 24) which runs in the circumferential direction of the shaft body (10) being formed into a circumferential face (14) of the tube by way of rolling of at least one roller (30, 31, 32, 33, 34), characterized in that the enveloping circle diameter (HK) of the bending section (13) is smaller than or equal to the sum of the enveloping circle diameter (D) of the tube and twice the wall thickness (s).

11. The method as claimed in claim 10, characterized in that the bending section (13) has a plurality of grooves (21, 22, 23, 24) which run in the circumferential direction of the shaft body (10) for the formation of a groove structure, the groove structure being of non-uniform configuration in the direction of the longitudinal axis (L).

12. The method as claimed in claim 10 or 11, characterized in that the grooves (21, 22, 23, 24) are formed by way of a roller (30), at least one first groove (21) being formed in a first longitudinal position of the roller (30), and one second groove (22) being formed in a second longitudinal position of the roller (30), which second longitudinal position is spaced apart axially from said first longitudinal position,
the roller (30) being advanced to a different extent onto the circumferential face (14) of the tube in the first and second longitudinal position,
and/or
the longitudinal positions of the roller (30) being spaced apart from one another to a different extent.

13. The method as claimed in claim 12, characterized in that the grooves (21, 22, 23, 24) are formed by way of at least two rollers (31, 32, 33, 34) which are spaced apart axially from one another, are arranged, in particular, along a common rolling axis (R), and have
a different roller geometry,
and/or
different spacings (a1, a2) between a first roller (31) and a second roller (32) and between the second roller (32) and a third roller (33).

14. The method as claimed in one of claims 10 to 13, characterized in that the length of the tube is identical before and after the forming.

15. The method as claimed in one of claims 10 to 14, characterized in that the steering shaft is configured as claimed in one of claims 1 to 9.
